(19) United States
(12) Patent Application Publication
(10) Pub. No.: US 2004/0227055 A1
(43) Pub. Date: Nov. 18, 2004

(54) Device for the reading-out and/or testing of matrices or optical storage media

(76) Inventors: Peter Hausberger, Radfeld (AT); Peter Pohl, Mlls bei Imst (AT)

Correspondence Address: Thomas M. Saunders, Brown Rudnick Berlack Israels LLP, One Financial Center, Box IP, Boston, MA, 02111, US

(21) Appl. No.: 10/840,091

(22) Filed: May 6, 2004

(30) Foreign Application Priority Data
May 9, 2003 (AT) A 714/2003

(51) Int. Cl. G02B 27/64; G11B 7/00

(52) U.S. Cl. 250/201.5; 369/44.11

(57) ABSTRACT

Device for the reading-out and/or testing of matrices or optical storage media (2) that have been set in rotation, with an opto-electronic scanning system (1), an electronic control device (18) for the opto-electronic scanning system (1), an amplifier device (7) for the amplification of the HF signals originating in the opto-electronic scanning system (1), a decoder device (10) for the decoding of amplified HF signals, and an optionally present signal-processing device (11) for the processing of amplified HF signals for a measurement and evaluation device (19), at least the amplifier device (7) that is able to be releasably connected to the opto-electronic scanning system (1) and the decoder device (10) being configured as separate modules (6, 9) which are preferably able to be releasably connected to each other via plug connectors (17′b) and/or connection lines (25).

### CROSS REFERENCES TO RELATED APPLICATIONS

This application is a continuation-in-part application of Austrian Patent Application No. A 714/2003, filed May 9, 2003.

### FIELD OF INVENTION

The invention relates to a device for the reading-out and/or testing of matrices or optical storage media that have been set in rotation, with an opto-electronic scanning system, an electronic control device for the opto-electronic scanning system, an amplifier device for the amplification of the HF signals originating in the opto-electronic scanning system, a decoder device for the decoding of amplified HF signals, and an optionally present signal-processing device for the processing of amplified HF signals for a measurement and evaluation device.

### BACKGROUND OF INVENTION

So-called “masters”, “fathers”, “mothers”, “sons” or “matrices” (called “matrices” for short in the following) are used for the duplication of optical media (such as compact discs (CDs in short), CD-ROM, CD-XA, CD-I, CD-R, CD-RW and other media based on the CD format, and of digital versatile discs (DVDs in short), DVD-ROM, DVD−R, DVD-RW, DVD+R, DVD+FW and other media based on the DVD format, and BLU-Ray media. These matrices are parts made of metal or glass or of plastics, which are produced and duplicated by means of exposure to light, etching, plasma etching, vacuum metallizing, partial evaporation, or electrochemically (galvanically). These and the end-products made from them (optical media, called replicas for short) contain mechanical structures (“bits”) which either themselves already represent the information that is to be read out (in the case of the pre-recorded versions of these media, the replicas), or else are guide or synchronization information for a subsequent writing process (in the case of the versions of these media that are writeable once or repeatedly, such as e.g. CD-R or DVD−R).

These structures (bits) are read out optically, the reading-out taking place through modulation of a reflected laser beam. The modulation takes place for example through reflection of the laser beam at a boundary surface, through interference at various planes of the structures, through scattering at the structures and through double refraction. The electric signals, information and measurement values derived from these structures (data) are also called “signals” in the following. Limit values are sometimes specified for the structures and the derived signals on the end-product (the replica), in order to meet international quality standards.

The quality-relevant properties of the media are fixed in the pertinent specifications, for example

| | |
|---|---|
| RED BOOK | for CD-Audio |
| ORANGE BOOK | for CD-R/RW |
| YELLOW BOOK | for CD-ROM |
| SCARLET BOOK | for SACD-Audio |
| DVD BOOK | for DVD-Audio |
| DVD BOOK | for DVD-ROM |
| DVD BOOK | for DVD-R/RW |
| DVD + R/RW | for DVD + R/RW |

In addition to the individual measurement parameters, the required optical properties of the measuring head are also described in these pertinent specifications. A distinction is therefore to be drawn between specification-compliant lens systems and so-called consumer lens systems such as are used in domestic appliances usual in the market.

Specification-compliant DVD drivers are currently supplied by only a few manufacturers world-wide.

Specification-compliant CD drivers are no longer available. All the measurement- and test-system manufacturers throughout the world therefore already built up appropriate stocks of CD drivers years ago. That is to say, there is an ever-increasing use of various consumer lens systems in measurement and testing systems for CDs.

A substantial technical outlay is necessary in order to be able to achieve, with consumer drivers, measurement results which approach those obtained with specification-compliant drivers. Comparability varies from signal to signal.

All the devices currently available for the testing of matrices and optical media are realized in driver form, with the control unit, measuring unit and the opto-electronic scanning system forming one unit. The individual functions of the control and measuring units respectively cannot be clearly separated.

The output signals (measurement signals) from the opto-electronic scanning system are small high-frequency currents which react correspondingly sensitively to interference. Therefore the control unit and the measuring unit are combined as compactly as possible in order to be able to achieve very short signal paths and group delays.

Every driver is thus specially optimized with a view to the use of a specific opto-electronic scanning unit. If the opto-electronic scanning unit is, or must be, replaced by another type (for reading another optical format), this means that a completely new driver comes about or must be configured.

For the manufacturer of optical media, the pertinently valid specifications are decisive. These guarantee the playability of an optical medium on all playback equipment available world-wide, such as CD audio players or CD-ROM drivers in computers which also comply with this specification.

Certain specifications are not and cannot be matched to each and every latest technical development in the consumer market (opto-electronic scanning systems which do not comply with the pertinent specifications are always coming into use e.g. in consumer players). Furthermore, the testing of the optical media must in most cases take place at single playback speed (1× for short) according to the pertinent specifications. Consumer players (principally drivers for computers, CD-ROM and DVD-ROM) use much higher read-out speeds (in the case of CDs over 72×, and over 40× in that of DVDs). Thus, the testing of the optical media according to the pertinent specifications can no longer unconditionally guarantee the playability of the medium.

This is why consumer lens systems are also being used to an ever-increasing extent for measuring and test systems in order to also examine playability at the same time as the medium is tested.

### SUMMARY OF INVENTION

The object of the invention is to create a device of the type named at the outset which avoids the disadvantages, listed above, of existing methods and devices and rapidly permits reliable checks with the most varied opto-electronic scanning systems. According to the invention this is achieved in that at least the amplifier device that is able to be releasably connected to the opto-electronic scanning system and the decoder device are configured as separate modules which are preferably able to be releasably connected to each other via plug connectors and/or connection lines.

The essential advantage of the invention is that, when exchanging the opto-electronic scanning system for another one, the whole of the downstream electronics no longer needs to be replaced with it, but it is generally sufficient to exchange just the module of the amplifier device, which can also carry out the signal matching for the following electronics, in particular an impedance matching. The electronic control device for the opto-electronic scanning system can be fitted on the module of the decoder device. But in order to achieve an even greater variability in respect of the replacement or exchange of opto-electronic scanning systems, it is more advantageous to also arrange the electronic control device or essential components of same on the module of the amplifier device and then optionally exchange them as well when exchanging or replacing the opto-electronic scanning system. Thus at any rate the module of the decoder device together with microcontroller can remain plus optionally other components present.

The amplifier device and the decoder device essentially suffice for pure play-back. If it is desired to carry out a test on matrices or other test objects, such as CDs or DVDs, it is advantageous to also provide a signal-processing device, preferably likewise as a releasably connectable module. This signal-processing device then receives the data from the opto-electronic scanning system likewise via the said amplifier device and communicates for its part with one or more standardized measuring cards.

The superordinated control of the whole system can take place from a central module with a processor device (for example a single-chip PC). This module is then advantageously in communication, via a freely programmable interface, with the decoder device on the one hand and the signal-processing device for the measuring card(s). This module with the processor device advantageously also includes a communication interface, in particular a LAN interface for a local network, for example Ethernet.

The preferred four modules for the amplifier device, decoder device, processor device and signal-processing device are advantageously arranged such that they lie at a right angle along the sides of an imaginary rectangular prism. This permits a good heat transfer through a selectively created air current and thus a small thermal impairment of the opto-electronic scanning system, and a slim construction in top view.

### BRIEF DESCRIPTION OF DRAWINGS

Further advantages and details of the invention are explained in more detail with the help of the following description of figures. There are shown in:

FIG. 1 schematically an embodiment according to the state of the art,

FIGS. 2 and 3 alternative embodiments of a device according to the invention, in each case in a block diagram, and

FIG. 4 schematically the arrangement of the printed circuit boards or individual modules of the invention.

### DETAILED DESCRIPTION

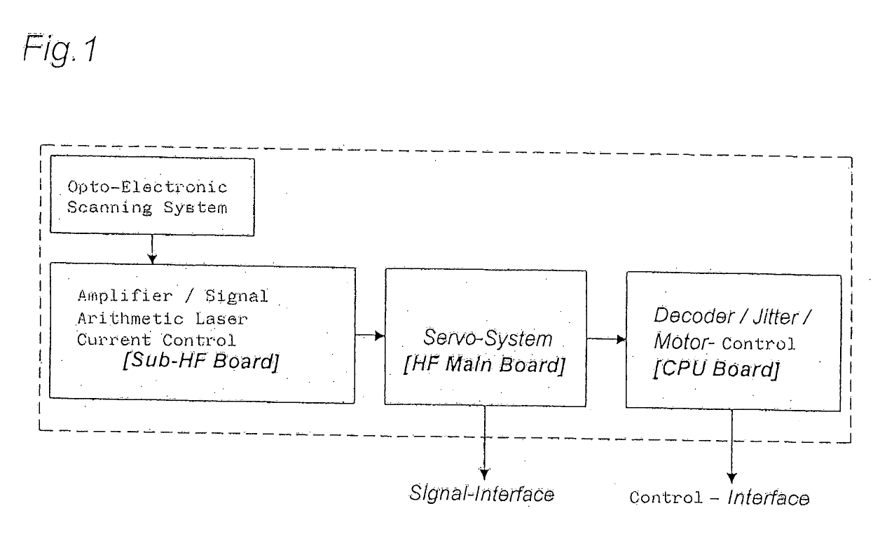

In the case of the state of the art shown in FIG. 1, the essential electronic components are housed on a single board. When the opto-electronic scanning system is exchanged, the whole board with all the electronic components must therefore be exchanged each time.

In order to avoid this, the invention proposes a modular structure, the individual modules preferably consisting of assembled printed circuit boards which advantageously are able to be connected to each other via plug-in connections directly and/or via interjacent, preferably flexible lines.

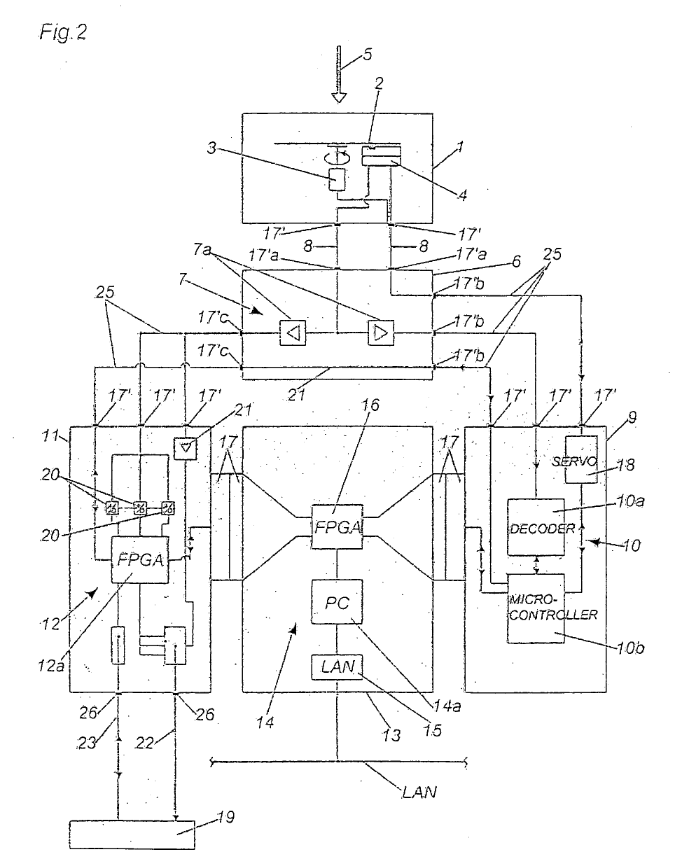

Referring to FIG. 2, the schematically represented opto-electronic scanning system is numbered 1. It serves to read out data from a matrix or test object 2, the sensitive high-frequency output signals being relayed to the succeeding electronics. The opto-electronic scanning system includes a schematically represented drive 3 and a measuring head 4, which is equipped in most cases with a laser and the reading part of which is able to be shifted radially relative to the matrix or the test object 2. In the case of the system according to the invention, the matrix can be introduced from above in the direction shown by the arrow 5 (top-loader). Ease of access is thus created. This top-loader version also permits easy incorporation into a production line for CDs or DVDs, in order to test these “in-line”.

The device according to the invention also includes a module 6 with an amplifier device 7 which, in the embodiment shown, consists of two amplifiers 7a which can also perform other signal-matching functions, for example an impedance matching for the succeeding electronics.

This amplifier device is connected to the electronic scanning system 1 via the shortest possible connection lines 8 and plugs 17′, 17′a. The outlets of the amplifiers 7a lead on the one hand to the module 9 of the decoder device 10 and on the other to the module 11 of the signal-processing device 12 (terminals 17′c, 17′b).

The decoder device 10 essentially comprises a decoder 10a and a microcontroller 10b which operates in real time. The decoder 10a can advantageously be configured as a plug-in component on the printed circuit board. It serves to convert the amplified high-frequency output signals of the electronic scanning device into digital data, and in so doing carry out an analysis in per se known manner, for example read out the address of data blocks, relay the data themselves in digital form, generate error signals or even correct errors.

The superordinated control is carried out by the module 13 with the processor device 14 which essentially comprises a single-chip PC 14a. This is in communication via an interface or intersection point 15 with the local network LAN (for example Internet). The PC 14a need not operate in real time. It is in communication via a freely programmable interface (FPGA) 16 on the one hand with the module 8 of the decoder device 10 and on the other with the module 11 of the signal-processing device 12, the connection being able to take place here either—as shown—via direct plug contacts 17 or—as shown further up in FIG. 2—via plugs and flexible lines.

If a CD or DVD 2 is merely to be played, the module 11 for the measurement-value processing device can be omitted. The decoded data are then output from the microcontroller via the FPGA 16 to the PC 14a and the LAN interface 15.

The control of the opto-electronic scanning unit, in particular of the drive motor 3 and of the actual opto-electronic reading head 4 (in particular of its position) is carried out by the control device 18 which, in the case of the embodiment shown in FIG. 2, is housed on the printed circuit board 9 of the decoder 10a, i.e. is assigned to the decoder module. The control data are transmitted via the lines 8 and 25. In the embodiment shown, these are looped through the amplifier module 6. However, a direct line guided parallel thereto could also be provided.

If matrices or test objects (CDs or DVDs 2) are now to be tested by the device according to the invention, the relevant data must ultimately reach a standardized measuring card 19 via the terminals 26. In order to have as great as possible a flexibility of plug-in opto-electronic scanning systems here also, a signal-processing device 12 is provided which includes, as central component, a freely programmable interface (field programmable gate array) 12a. The amplified HF signals of the opto-electronic scanning system are fed in digital form to this interface on the one hand via a series of analog-to-digital converters 20, and on the other the FPGA 12a can also receive digital data from the microcontroller 10b, these being guided, in the case of the embodiment shown, via a signal bridge 21 in the module 6 of the amplifier device 7. In principle it is also possible to feed data from the control device 18 to the FPGA (not shown here). In addition, HF data from the opto-electronic scanning system can be amplified once more via an amplifier 21, so that ultimately digital and analog signals are able to be fed to the measuring card 19 via the measurement-data line 22. This measuring card 19 can be in communication with the module 11 via a synchronization line 23.

It should be mentioned at this point that the lines shown are merely schematic lines. They can be realized in the most varied ways, for example as flexible lines or as track conductors on boards. Also, the lines that are shown as single can certainly also represent multiple lines, for example in the sense of a flat-band cable. Moreover, for the sake of simplicity the whole power supply to the individual components is not shown.

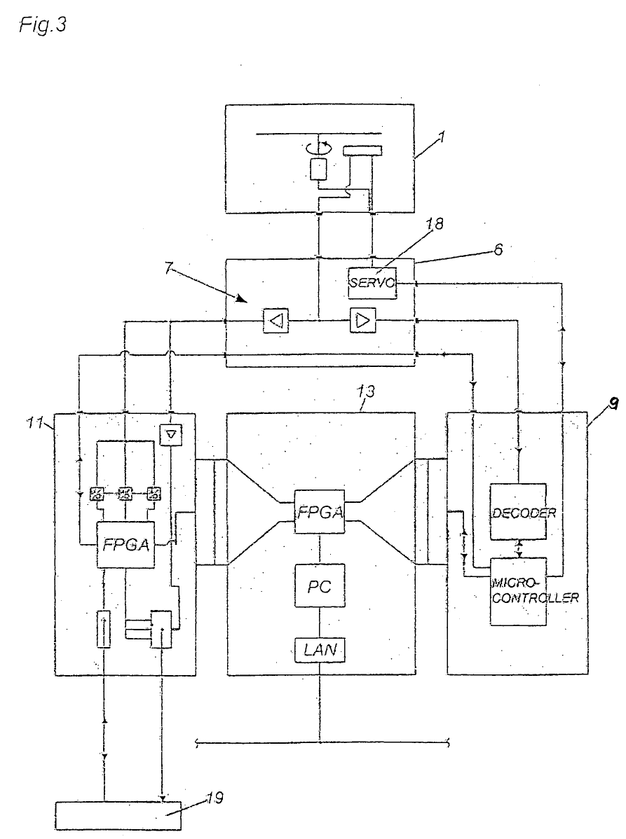

In the case of the embodiment shown in FIG. 3, the opto-electronic scanning system 1 and the modules 6, 9, 11 and 13 have the same structure in principle as in FIG. 2. The essential difference is however that in the case of the embodiment according to FIG. 3 the control device 18 for the opto-electronic scanning system 1 is arranged on the module 6 of the amplifier device 7. An even greater flexibility is thus achieved, because when the driver 1 is being exchanged or replaced by another one, only the module 6 has to be exchanged with it. The other electronic components 9, 11 and 13 and the measuring card 19 can remain the same.

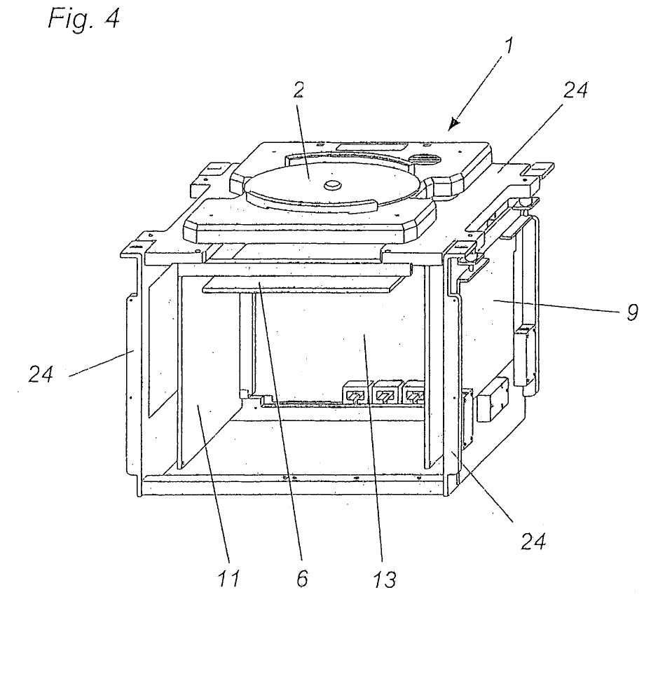

FIG. 4 shows an advantageous three-dimensional arrangement of the individual modules or printed circuit boards 6, 9, 11 and 13. These printed circuit boards or modules are equipped with electronic circuit elements which are schematically represented for example in FIG. 2 in the block diagram. These circuit elements and also connection lines are not shown in FIG. 4, for the sake of clarity. The circuit elements advantageously lie—at least for the most part—on the outward-facing side of the shown imaginary cube. The modules or printed circuit boards 9, 11, 13 and 6 are arranged perpendicular to each other and held in a common mount (metal frame structure) 24. This mount also still carries on its upper side the opto-electronic scanning system 1 for the test object 2. The advantage of this arrangement is an easy accessibility of the individual printed circuit boards or modules, and a reduced thermal load for the opto-electronic scanning system 1, because the electronic components of the individual printed circuit boards are removed and arranged laterally offset, which means that—contrary to what happens with other known systems—there is no substantial heating of the opto-electronic scanning system when cooling air is supplied from below. Moreover, the three-dimensional “rectangular prism arrangement” of the printed circuit boards, in which at least the printed circuit boards 9, 11 and 13 are arranged upright, permits a slim structure in top view, which is advantageous for use in in-line operation. The somewhat increased mounting height actually does not play that important a role there.

The invention is naturally not limited to the shown embodiments—the essential feature is the modular structure of the electronics.

What is claimed:

1. Device for the reading-out and/or testing of matrices or optical storage media that have been set in rotation, with an opto-electronic scanning system, an electronic control device for the opto-electronic scanning system, an amplifier device for the amplification of the HF signals originating in the opto-electronic scanning system, a decoder device for the decoding of amplified HF signals, and an optionally present signal-processing device for the processing of amplified HF signals for a measurement and evaluation device, wherein at least the amplifier device that is able to be releasably connected to the opto-electronic scanning system and the decoder device are configured as separate modules which are able to be releasably connected to each other.

2. Device according to claim 1, wherein the electronic control device for the opto-electronic scanning system is arranged on the module that includes the amplifier device.

3. Device according to claim 1, wherein the electronic control device for the opto-electronic scanning system is arranged on the module that includes the decoder device.

4. Device according to claim 1, wherein the amplifier device, the decoder device and the signal-processing device are each configured as separate modules.

5. Device according to claim 4, wherein the module of the amplifier device includes at least a first terminal for the opto-electronic scanning system, at least a second terminal for the decoder device and a third terminal for the signal-processing device.

6. Device according to claim 1, wherein a further module with a processor device is provided, which is able to be releasably connected to at least one of the modules of the decoder device or the signal-processing device.

7. Device according to claim 6, wherein the processor module includes a terminal for the decoder device and a terminal for the signal-processing device.

8. Device according to claim 6, wherein the module of the amplifier device is releasably connected to the module of the decoder device on the one hand and to the module of the signal-processing device on the other and the module of the processor device is likewise connected to the module of the decoder device and to the module of the signal-processing device.

9. Device according to claim 1, wherein the modules include at least partly flexible programmable interface devices, preferably field programmable gate arrays (FPGAs) for communication with other modules.

10. Device according to claim 1, wherein the module of the amplifier device includes two amplifiers, the outlet of one amplifier leading to the terminal for the signal-processing device and the outlet of the other amplifier to the terminal for the decoder device.

11. Device according to claim 1, wherein the module of the amplifier device includes a continuous signal bridge between two terminals, the first terminal being provided for the decoder device and the second terminal for the signal-processing device.

12. Device according to claim 1, wherein the decoder device includes a plug-in decoder chip held releasable in a mount.

13. Device according to claim 1, wherein the decoder device includes a real-time-capable microcontroller which is in communication with the actual decoder, and preferably also with the control device, the processor device and via the signal bridge of the module of the amplifier device with the signal-processing device.

14. Device according to claim 1, wherein the processor module includes a LAN interface, in particular an Ethernet interface.

15. Device according to claim 1, wherein the signal-processing device includes several parallel analog-to-digital converters, the outputs of which are fed to a freely programmable interface device, preferably a field programmable gate array (FPGA).

16. Device according to claim 1, wherein the signal-processing device includes at least a terminal for the releasable connection of an external measuring card.

17. Device according to claim 1, wherein the modules are at least partly designed as assembled printed circuit boards.

18. Device according to claim 17, wherein the assembled printed circuit boards are able to be releasably connected to a common mount, preferably a metal frame.

19. Device for the reading-out and/or testing of matrices or optical storage media that have been set in rotation, with an opto-electronic scanning system, an electronic control device for the opto-electronic scanning system, an amplifier device for the amplification of the HF signals originating in the opto-electronic scanning system, a decoder device for the decoding of amplified HF signals, and an optionally present signal-processing device for the processing of amplified HF signals for a measurement and evaluation device, wherein the electronic components are arranged on printed circuit boards and the printed circuit boards are arranged at a right angle to each other.

20. Device according to claim 19, wherein the printed circuit boards comprise the printed circuit board of the module of the amplifier device, the printed circuit board of the module of the decoder device, the printed circuit board of the module of the processor device and the printed circuit board of the signal-processing device.

21. Device according to claim 19, wherein the printed circuit boards are arranged essentially along the sides of an imaginary rectangular prism or a cube (FIG. 4).

22. Device according to claim 20, wherein the printed circuit board of the module of the amplifier device is arranged in the area of the top surface of the imaginary rectangular prism or cube, in that the printed circuit board of the module of the processor device is arranged at the front or rear side of the imaginary rectangular prism or cube, and in that the printed circuit boards of the modules of the signal-processing device and of the decoder device are arranged at the side surfaces of the imaginary rectangular prism, preferably cube, or form these (FIG. 4).

23. Device according to claim 1, wherein the opto-electronic scanning system is arranged above the printed circuit board of the module of the amplifier device at a common mount for all the printed circuit boards of the modules (FIG. 4).
